(19) United States
(12) Patent Application Publication
(10) Pub. No.: US 2004/0223062 A1
(43) Pub. Date: Nov. 11, 2004

(54) Pan and tilt camera system

(76) Inventors: Richard Pettegrew, Parma Heights, OH (US); Michael Dobbs, Berea, OH (US); Eric Anderson, North Olmsted, OH (US); William Yanis, Streetsboro, OH (US); John Matthew Paximadis, Westlake, OH (US); Richard Stepnowski, Cleveland, OH (US); Paul Ferkul, Cleveland, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/429,297

(22) Filed: May 5, 2003

(51) Int. Cl. H04N 7/18

(52) U.S. Cl. 348/211.4; 348/208.99; 348/211.7; 348/207.99; 348/143

(57) ABSTRACT

A pan and tilt camera system is provided. The system involves positioning a payload (e.g., camera, sensor, controlling electronics) with its center of mass substantially centered over both the pan and tilt axes, which facilitates increasing the payload of a pan and tilt system by reducing and making more constant the load on panning and/or tilting motors. With the more constant motor loads, smoother and finer camera and/or sensor control is possible than with conventional systems. Example systems also provide for belt drive motors, a survivable casing, and a casing adapted for a larger variety of lens sizes.

### TECHNICAL FIELD

The systems described herein relate generally to pan and tilt camera systems and more particularly to pan and tilt systems for one or more sensors (e.g., optical camera, infrared camera, laser range finder, directional microphone), associated electronics, and/or computer components that reduce and make more constant the load on motors employed in panning and/or tilting to facilitate increasing payloads and making pan and/or tilt control more precise.

### BACKGROUND

Conventionally, pan and tilt systems have had limited payload (e.g., cameras, sensors, associated electronics) capacities due, at least in part, to limitations associated with panning and/or tilting motors, where the limitations are created by the geometry of the pan and tilt axes and the relationship of the pan and tilt payload to the pan and tilt axes. Conventional apparatus for panning (rotating) may include a chain, direct, cable, and/or gear drive powered by a motor(s) that rotate a system about a fixed base. A typical apparatus for tilting may include a chain, direct, cable and/or gear drive powered by a motor(s) attached to the panning apparatus. In a conventional system, loads on the tilting motor(s) may be variable and increase in certain pan/tilt configurations due to the undesired application of the payload mass on a moment arm associated with the tilt axis. The increasing loads, particularly in dynamic situations (e.g., bouncing) can lead to overstressing and/or overloading a motor, even stopping it from functioning in some cases. Furthermore, the variability of loads that a motor must handle reduce the control precision achievable in conventional systems. For example, a first movement command may yield a first result under a first load, but the same movement command may yield a different result under a second load. Thus, the payload and precision of pan and tilt systems has historically been limited, which resulted in corresponding limits on panning and tilting applications (e.g., area monitoring, intrusion detection). Payload capacity restrictions and precision restrictions have limited the value of pan and tilt systems, especially in mobile applications where dynamic loads (e.g., shaking, rattling, harmonic motion) can exacerbate the effects of applying the payload mass on a moment arm associated with the tilt axis. Furthermore, the restricted payload capacity has limited the ability to include additional onboard electronics, additional cameras, sensors and so on, further limiting the value of pan and tilt systems.

### SUMMARY

The following presents a simplified summary of example panning and tilting camera systems to facilitate providing a basic understanding of these systems. This summary is not an extensive overview and is not intended to identify key or critical elements of the example systems or to delineate the scope of these systems. This summary provides a conceptual introduction in a simplified form as a prelude to the more detailed description that is presented later.

The example systems described herein position the pan and tilt payload (e.g., cameras, sensors, onboard electronics, onboard computer components) to facilitate stabilizing and balancing the payload. The example systems position the payload to facilitate reducing and making more constant the loads on panning and/or tilting motors. In one example, the load on the tilt motor(s) is substantially constant regardless of the position of the payload. One example system employs a saddle mount tilt drive with substantially no moment arm to facilitate reducing and making more constant the load on a tilt motor. Furthermore, the example systems may employ belt drives powered by a motor(s) to apply forces to pan and/or tilt the payload. With the forces on the motors reduced and made more constant, larger and/or more varied payloads can be carried and controlled more precisely, which results in more varied and valuable applications for pan and tilt systems. In one example, a more survivable cover can be employed to protect a pan and tilt system. In another example, the variety of sizes of the camera(s) can be increased and thus the more survivable payload cover is adapted to accommodate a larger range of lens sizes. In yet another example, direct current (DC) can be employed to power the system without AC to DC conversion and/or conventional AC power can be employed.

Certain illustrative example systems are described herein in connection with the following description and the annexed drawings. These examples are indicative, however, of but a few of the various ways in which the principles of the systems may be employed and thus are intended to be inclusive of equivalents. Other advantages and novel features may become apparent from the following detailed description when considered in conjunction with the drawings.

### BRIEF DESCRIPTION OF THE DRAWINGS

FIG. 1 illustrates an example pan and tilt system.

FIG. 2 illustrates an example pan and tilt system.

FIG. 3 illustrates an example pan and tilt system.

FIG. 4 illustrates top, side and front views of an example pan and tilt IR camera system.

FIG. 5 illustrates a perspective view of portions of an example pan and tilt IR camera system.

FIG. 6 illustrates a perspective view of portions of an example pan and tilt IR camera system.

FIG. 7 illustrates a perspective view of portions of an example pan and tilt IR camera system.

FIG. 8 illustrates an exploded view of portions of an example pan and tilt IR camera system.

### LEXICON

“Logic”, as used herein, includes but is not limited to hardware, firmware, software and/or combinations of each to perform a function(s) or an action(s). For example, based on a desired application or needs, logic may include a software controlled microprocessor, discrete logic such as an application specific integrated circuit (ASIC), or other programmed logic device. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Signal”, as used herein, includes but is not limited to one or more electrical or optical signals, analog or digital, one or more computer instructions, a bit or bit stream, or the like.

“Software”, as used herein, includes but is not limited to, one or more computer readable and/or executable instructions that cause a computer, computer component, and/or other electronic device to perform functions, actions and/or behave in a desired manner. The instructions may be embodied in various forms like routines, algorithms, modules, methods, threads, and/or programs. Software may also be implemented in a variety of executable and/or loadable forms including, but not limited to, a stand-alone program, a function call (local and/or remote), a servelet, an applet, instructions stored in a memory, part of an operating system or browser, and the like. It is to be appreciated that the computer readable and/or executable instructions can be located in one computer component and/or distributed between two or more communicating, co-operating, and/or parallel processing computer components and thus can be loaded and/or executed in serial, parallel, massively parallel and other manners. It will be appreciated by one of ordinary skill in the art that the form of software may be dependent on, for example, requirements of a desired application, the environment in which it runs, and/or the desires of a designer/programmer or the like.

An “operable connection” (or a connection by which entities are “operably connected”) is one in which signals, physical communication flow, and/or logical communication flow may be sent and/or received. Usually, an operable connection includes a physical interface, an electrical interface, and/or a data interface, but it is to be noted that an operable connection may consist of differing combinations of these or other types of connections sufficient to allow operable control.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program and a computer. By way of illustration, both an application running on a server and the server can be computer components. One or more computer components can reside within a process and/or thread of execution and a computer component can be localized on one computer and/or distributed between two or more computers.

“Computer communications”, as used herein, refers to a communication between two or more computer components and can be, for example, a network transfer, a file transfer, an applet transfer, an email, a hypertext transfer protocol (HTTP) message, a datagram, an object transfer, a binary large object (BLOB) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

### DETAILED DESCRIPTION

Example systems are now described with reference to the drawings, where like reference numerals are used to refer to like elements throughout. In the following description for purposes of explanation, numerous specific details are set forth in order to facilitate thoroughly understanding the systems. It may be evident, however, that the systems can be practiced without these specific details. In other instances, well-known structures and devices are shown in block diagram form in order to simplify description.

The example systems described herein are designed to position the pan and tilt payload (e.g., cameras, sensors, onboard electronics, onboard computer components) in a stable balanced position. In one example, the stable balanced position is achieved by using a saddle mount tilt drive with substantially no moment arm. The stable and balanced position facilitates reducing and making more constant the loads experienced by panning and/or tilting motors. In one example, the load on the tilt motor(s) is substantially constant regardless of the position of the payload. Reducing and/or making more constant the loads on the motor(s) facilitates increasing payload capacity and improving control precision. Similarly, reducing and/or making more constant the loads on the motor(s) facilitates increasing the speed at which the payload can be moved, started, stopped and/or changed while reducing wear and tear on the system.

The positioning includes locating one or more elements of the payload (e.g., cameras, sensors, electronics) so that the tilt axis pivots approximately about the center of mass of the payload. Preferably, the center of mass of the payload is located so that the tilt axis pivots precisely about the center of mass of the payload. However, those skilled in the art will appreciate that deviations from the precise center of mass are to be expected. In one example, if the center of mass of the payload is off axis, the system will counterbalance the payload. The positioning thus reduces and makes more constant the load on the tilt motor(s). Additionally, the tilt axis is located perpendicular to the pan axis in the same plane as the pan axis. This further reduces and makes more constant the load on the tilt motor(s) and/or pan motor(s).

Since the load on the motor(s) is reduced, larger payloads can be carried. Thus, multiple cameras systems can be produced. For example, a system that includes both a visible imaging camera and an infrared (IR) camera can be supported. Similarly, more extensive onboard electronics can be employed. Thus, more local control can be exercised over the system. Furthermore, additional sensors (e.g., laser range finder) can be incorporated into a pan and tilt system. Thus, one example includes a pan and tilt system with a visible imaging camera, an infrared camera, and a laser range finder. Another example includes components, onboard electronics, and/or computer components that control the combined visible/infrared system.

Since the load on the motor(s) is made more constant, more precise control can be exercised over the system. Thus, a camera(s) can be moved more precisely. This facilitates programming more intricate and/or more thorough scanning paths for an intrusion detection system, for example. The additional precision also supports applications where long range optics are employed for the visible and/or IR cameras. The additional precision facilitates aiming the optics at distant targets that may not be targetable by conventional systems. By way of illustration of the value of the additional precision, consider a system that can be aimed in 1 degree increments. At a range r, there will be an arc distance of (π*r/180) between targetable points. If the range r is large, then the arc distance may exceed the field of view at the range. Thus, it may be difficult, if possible at all, to target an object at a large range r. However, if the system can be aimed in more precise increments (e.g., 0.1 degrees) then the arc distance at range r will be (π*r/1800), making it less likely that the arc distance will exceed the field of view at the range. Similarly, more precise control facilitates more rapidly and accurately focusing in on a region of interest. For example, a motion detection system may detect a movement at a certain range. With more precise control, the camera(s) may be more rapidly and accurately positioned to examine the region. More precise control is also facilitated, in one example, by employing DC servo motors with pulse width modulation (PWM) control for the panning and/or tilting motors.

An effect of reduced load and more precise control is illustrated in the following example. Conventionally, pan and tilt observation systems are limited in how fast they can move and how fast they can change direction, particularly in some pan/tilt configurations. Thus, some conventional pan and tilt observation systems can be defeated by various movement types in certain regions that yield motor stressing pan and tilt configurations. In a system where the tilt axis pivots approximately about the center of mass of a payload and where the tilt axis is arranged perpendicular in the same plane as the pan axis, movement speed and change of direction speed can be improved to the point where the observation system will not be defeated like the conventional system. For example, an object that enters a field of view may attract the attention of the pan and tilt based observation system. Once the system is engaged, and movement towards the object begins, the object may successfully exit the field of view by traveling at a high rate of speed in a direction and/or pattern that will cause the pan and tilt system to experience a maximum load, potentially overstressing and freezing a motor(s). However, with the example systems described herein, the pan and tilt system can change direction more quickly and follow the object more rapidly.

Example systems employ belt drive linkages to apply power from a motor(s) to generate panning and/or tilting forces in panning and/or tilting equipment. Conventionally, chain and/or gear drive systems have been employed to transfer force from the motor(s) to the panning and/or tilting equipment. But, conventional systems with gears, chains and so on may be excessively noisy for some security applications or may require excessive maintenance. The belt driven systems described herein can be relatively quieter than chain and/or gear systems, which facilitates their use in certain security applications. Furthermore, the belt drive systems may require less maintenance and be more reliable. Thus, one example system is configured so that the tilt axis pivots approximately about the center of mass of a payload and so that the tilt axis is arranged perpendicular in the same plane as the pan axis. In the example system, the payload is panned and/or tilted in response to a force(s) generated in a motor and transmitted to the apparatus supporting the payload by belt drive equipment.

In another example system, a more survivable cover is employed. The cover may enclose the pan and tilt system, may substantially enclose the system, and/or may partially enclose the system, for example. By way of illustration, a survivable cover is one that is designed to withstand weather (e.g., rain, sand, freeze and thaw, heat), field usage (e.g., vibration, shock loading), field action (e.g., laser energy, kinetic energy (bullet)), and other conventional destructive forces. A survivable cover may cause the weight supported and/or moved by a conventional system to exceed a desired range. Thus, conventional systems may not employ a survivable cover opting instead for a lighter material. Survivable covers are made from carbon fiber and/or Kevlar, for example.

Traits like the survivability and usefulness of an example system can be further enhanced by components like an automatic repositioning logic and an internal climate control component. The automatic repositioning logic can, for example, selectively reposition the payload collectively and/or one or more sensors individually based, for example, on the occurrence of a pre-determined condition (e.g., power loss, sleep command). One selective repositioning places the optics windows facing directly down, which protects the optics windows and/or lenses from impacts and debris when the system is not in use. Another selective repositioning places the optics windows facing directly away from an identified threat that is being engaged while yet another selective repositioning places the optics windows facing directly towards an identified threat that is being engaged. It is to be appreciated that these are but three examples of automatic selective repositioning and that other examples are possible.

Pan and tilt systems can be employed in a wide variety of environments, ranging from arctic cold and dry, to monsoon heat and moisture. These varying environments can have undesired effects on sensors supported by a pan and tilt system. For example, a camera may freeze, or a lens may become occluded with condensation. Thus, example systems may include an internal climate control component. The climate control component may be, for example, a heater. While a heater is described, it is to be appreciated that other climate control components may be employed.

In yet another example, the cover is adapted to accommodate a larger range of lens sizes. Conventionally, perhaps due to weight restrictions, the opening in the cover has been restricted to a small range of lens sizes. When a lens outside the range is required, conventionally the cover has to be changed to accommodate the different lens size. Due to the larger payloads supported by a system where the tilt axis pivots approximately about the center of mass of a payload and where the tilt axis is arranged perpendicular in the same plane as the pan axis, a larger variety of camera lenses may be encountered. Thus, the system cover is adapted to accommodate a wider variety of lenses. In one example, lens sizes from 18 mm to 320 mm can be accommodated. It is to be appreciated that lens sizes greater and/or smaller than the 18 mm to 320 mm range can be accommodated.

Conventionally it has been difficult, if possible at all, to mount and use a pan and tilt system on a movable platform (e.g., humvee, APC, tank, unmanned drone, landing craft, destroyer) due to amplitude acceleration loading. Extreme off road vehicles (e.g., marine recon vehicles) generate an environment, from a mechanical standpoint, in which relatively high amplitude acceleration loading is combined with relatively high frequencies, often in varying directions. Thus, conventional systems typically cannot be employed with this platform. However, this is a platform that may benefit from a precision controllable blended visual IR system. One difficulty arises when motion (e.g. bumps, waves) encountered by the movable platform causes additional forces to be exerted by the payload on the tilt moment arm. In some cases, these forces can break the supporting member and/or overstress the load on a tilt motor(s). Additionally, a common problem associated with conventional systems subjected to high amplitude accelerations is that the positioning accuracy of the system becomes compromised. The changing dynamic loads can, in some cases, cause panning and tilting apparatus to slip due, for example, to backlash in the drive-train (e.g., looseness in gears). With the system arranged so that the tilt axis pivots approximately about the center of mass of a payload and so that the tilt axis is arranged perpendicular in the same plane as the pan axis, the additional forces encountered in a movable platform environment can be accounted for without overstressing the tilt motor(s). Additionally and/or alternatively, accuracy in aiming the device is more easily maintained.

Conventionally, perhaps due to payload limitations, it has been common to mount only a single camera in a pan and tilt system. While some conventional systems may mount multiple imagers and/or devices, movement precision may suffer due to the additional weight. Furthermore, it has been common to employ external (e.g., not on board) electronics and/or computer components to control the pan and tilt system. Again, while some conventional systems may mount internal electronics, the additional weight, typically loaded off axis, can exacerbate undesirable load producing conditions, further limiting conventional systems. With the additional payload capacity and precise controlling possible in a system where the tilt axis pivots approximately about the center of mass of a payload and where the tilt axis is arranged perpendicular in the same plane as the pan axis, the typically external electronics and/or computer components can be moved inside the pan and tilt system. This facilitates local processing without requiring network communications, making for a more compact, self-contained system. Additionally, and/or alternatively, this facilitates configuring the pan and tilt system in network configurations and/or client/server configurations with local intelligence in the system. When the onboard electronics and/or computer components are further supported with local power (e.g., battery), this facilitates survivability during a network outage and/or when data and/or power communications are compromised.

Another example system is “drop deployable”. A military application illustrates drop deployable systems. By way of illustration, a military unit may make a move into enemy territory and then desire to monitor an area. Thus, the unit may enter the area, send out patrols (e.g., on foot, mounted), and drop deploy a pan and tilt system. The pan and tilt system may employ single cameras and/or may blend visual and IR processing. In one example, the pan and tilt system may include a global positioning system (GPS) receiver. Thus, the pan and tilt system may be able to receive a GPS coordinate fix, determine its whereabouts, and programmatically determine a sector from which an enemy intrusion is most likely. Thus, a pre-programmed search pattern may scan that sector more frequently than another sector. This may have particular value when a unit becomes disoriented during an engagement, or becomes focused on a particular region during an engagement. The GPS enabled unit may be able to maintain its focus on a sector (e.g., bridge) in the face of a demonstration or diversion in another sector.

After a while, the military unit may move on, engage the enemy, and perhaps capture prisoners of war (POWs). Now the military unit may be tasked with guarding the POWs until a follow on military police (MP) unit arrives. While an area may be enclosed with concertina wire, fighting manpower may be taken out of the unit to guard the POWs. A drop-deployable pan and tilt system can facilitate guarding the POWs with less manpower, thereby mitigating the negative effects on combat readiness generated by guarding POWs.

While drop deployable systems support military applications, the systems are not so limited. By way of illustration, police may wish to monitor and/or control a crime scene. Thus, in addition to stringing yellow tape, the police may establish a perimeter using various human and/or automated assets. For example, the police may set a pan and tilt system on a tripod to monitor the crime scene. This type of drop deployable unit encounters various challenges. For example, signals generated by the unit may need to be transmitted over a long distance (e.g., to police command post). Similarly, the system may need to receive power and/or commands from a remote site (e.g., police command post). Thus, one example system includes fiber optic processing components and logic for receiving and/or transmitting a bidirectional command, data and/or signal stream. In one example, imaging and non-imaging data can be compressed and transmitted/received over the fiber optic apparatus, which facilitates locating the drop deployable system further away from control centers than is conventionally possibly.

In a related example, the drop deployable system may be established, for example, on or near a vehicle. When a system is established in a “short range environment” (e.g., vehicle) in a drop deployable or more permanent manner, it may encounter a different set of challenges. For example, a pan and tilt system typically operates on direct current. Conventionally, alternating current is provided to a pan and tilt system, and then alternating current to direct current conversion occurs. However, in the vehicle situation, a vehicle may have DC current (e.g., 12V DC) available. Thus, in one example, in a system where the tilt axis pivots approximately about the center of mass of a payload and the tilt axis is arranged perpendicular in the same plane as the pan axis, the system includes a DC current receiver, eliminating the additional step of converting AC current to DC current. The DC current can be employed to power, for example, panning motors, tilting motors, onboard electronics, onboard computer components, and so on. Example systems may include an AC receiver, a DC receiver, or both.

Given the range of situations in which the system may be deployed, one example system includes a pan and tilt unit, an adapter, and an application specific equipment and/or electronics unit. Thus, rather than a conventional one-size-fits-all system, the example systems described herein can be pre-configured and/or field-configured to respond to various needs. For example, a first application for a system may include a payload of a visible imaging camera. Thus, the first application may be pre-configured and the system deployed with the optical camera and application specific equipment, electronics and/or computer components to support the optical system. However, at another time, a second application for the system may be desired. Rather than scrapping the first system and employing a second system, example systems described herein can be reconfigured. For example, an infrared camera and associated application specific equipment, electronics and/or computer components can be added to the payload. In one example, the survivable cover can be opened, the additional items added, and the survivable cover closed again. At still another time, a third application for the system may be desired. Once again, rather than employing a third system, an example system described herein can be reconfigured. For example, a laser range finder, a directional microphone and associated application specific equipment, electronics and/or computer components can be added to the system.

In one example, because the system has the tilt axis pivot about the approximate center of mass of a payload and because the tilt axis is arranged perpendicular and in the same plane as the pan axis, the addition and/or removal of components does not substantially alter the load(s) placed on the tilt motor(s). Thus, problems in conventional systems associated with reprogramming movement command electronics and/or computer components when a payload is altered are mitigated. By way of illustration, in a conventional system, a first payload with a first mass will require a first set of motor commands to (re)position the payload while a second payload with a second mass will require a second set of motor commands. In one example system described herein, where the tilt axis pivots approximately about the center of mass of a payload and the tilt axis is arranged perpendicular in the same plane as the pan axis, one set of motor commands can be employed with different payloads, mitigating problems associated with conventional systems that may require reprogramming and/or recalibrating.

Reconfiguring is not limited to changing the internal components. Reconfiguring can also include placing the pan and tilt system on a variety of platforms, which is facilitated by a reconfigurable base. For example, a first system with a visible imaging camera and IR camera package may include an adapter that facilitates mounting the first system on a vehicle. When the vehicle comes to rest and wants to increase its monitoring field, the first system may be removed from the vehicle (where human eyes may scan a sector) and mounted on a tripod that is then located away from the vehicle to expand the coverage area. The tripod may contain a DC power source (e.g., battery) and contain connectors for wired and/or wireless data transmission. Thus, having the adapter and/or reconfigurable base on the system facilitates installing the system on different apparatus that may have varying electrical, data communication and other interfaces.

By incorporating additional onboard electronics and/or computer components, example pan and tilt systems described herein can be integrated into a computer network and/or communicate, via computer communications for example, with a variety of related systems and methods. Conventionally, perhaps due to payload weight restrictions, onboard electronics and/or computer components were not included in pan and tilt systems. Thus, the command and control functions performed by the related electronics and/or computer components were performed by external (e.g., off board) systems. Since the example systems can incorporate onboard electronics and/or computer components, the example systems can implement a communications protocol that facilitates interacting with diverse systems. Rather than learning the internals of the system, an external entity can learn the protocol and interact with the system through the protocol. The protocol can be employed to initiate actions like panning a payload, tilting a payload, controlling other sensors, inquiring about a device health, monitoring the status of the system, monitoring the status of communications, monitoring power access, monitoring power usage, and so on.

The protocol facilitates interacting with, for example, an infrared based intrusion system. By way of illustration, a monitoring computer in computer communication with a pan and tilt system may include software for analyzing infrared images. By implementing and employing the protocol to the pan and tilt system, the monitoring computer can control the pan and tilt system and receive imaging data without learning the internals of the pan and tilt system. By way of further illustration, a monitoring computer in computer communication with a pan and tilt system may include software for analyzing both optical and infrared images and, based on the analysis, directing the pan and tilt system. Again, by implementing and employing the protocol to the pan and tilt system, the monitoring computer can control the pan and tilt system and receive imaging data from the system without learning the internals of the pan and tilt system.

In one example, an electrical interface on the pan and tilt system facilitates integrating the system into a multi-drop serial network. The electrical interface facilitates integrating the pan and tilt system with a variety of standard devices. For example, by implementing and employing the electrical interface to the pan and tilt system, the pan and tilt system may be incorporated into a first multi-drop serial network, used for a period of time, then, as needs change, removed from the first network and installed in a second multi-drop serial network.

By incorporating additional onboard electronics and/or computer components, example pan and tilt systems described herein can also perform local image processing typically performed by external components like computers and frame grabbers. By way of illustration, an example system can include a colorization logic that facilitates taking a monochrome IR image and producing a colored and/or pseudo-colored image locally, without employing external components like a computer or frame grabber. Additionally, and/or alternatively, an example system can include an image stabilizing logic. While image stabilizing is known in the art, conventional pan and tilt systems have typically not included onboard image stabilizing. Thus, example systems described herein may include computer components and/or logics for stabilizing an image, visible and/or IR. One example system may combine both a colorization computer component and/or logic and a stabilizing computer component and/or logic.

In another example of processing performed by additional onboard electronics and/or computer components, an example system may include computer components and/or logics for target tracking and/or lock-on. While target tracking is known in the art, it typically is not performed by on board computer components in a pan and tilt system. Incorporating computer components for target tracking and/or lock-on into a pan and tilt system facilitates an application like keeping the camera(s) and/or other sensors pointed at a target when there is relative motion. The relative motion may be due, for example, to the target moving and/or the platform on which the pan and tilt system is mounted moving.

In yet another example, additional onboard electronics and/or computer components implement an infrared intruder alert system. For example, the onboard computer components can locally implement a system that detects the presence of an object in a region of interest, identifies the object based on its thermal signature, and selectively raises an alarm based, for example, on the heat signature of the detected object.

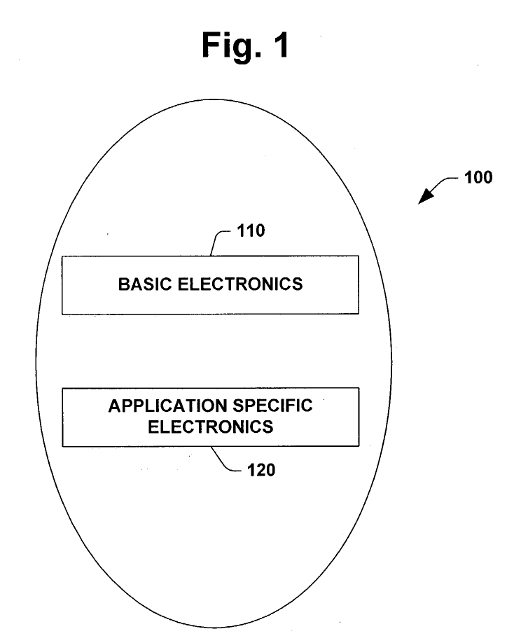

Turning now to FIG. 1, a set 100 of electronics entities (e.g., logics, computer components) located onboard a pan and tilt system are illustrated. The first electronic entity 110 is a set of basic electronics that would be included, for example, in substantially all configurations of a pan and tilt system where the tilt axis pivots approximately about the center of mass of a payload and where the tilt axis is arranged perpendicular to and in the same plane as the pan axis. While a first set of electronics is illustrated, it is to be appreciated that the first set may include items like electronics, computer components, and so on. The second electronic entity 120 is a set of application specific electronics that support a particular configuration for a particular application. While a second set of electronics is illustrated, it is to be appreciated that the second set may include items like electronics, computer components, and so on.

To illustrate the application of the separate sets, the first set of basic electronics may implement the protocol for communicating with the pan and tilt system and basic pan and tilt functionality for a single camera (e.g., pan, tilt, zoom, reset, status). The second set of electronics may support a second camera and/or sensor, for example. Conventionally, it was difficult, if possible at all, to “mix and match” onboard electronic components in a pan and tilt system due to the limited space available inside a system and due to the weight restrictions. However, with the additional payload volume and mass available in a system where the tilt axis pivots approximately about the center of mass of a payload and where the tilt axis is arranged perpendicular to and in the same plane as the pan axis, more onboard electronics are supportable. Furthermore, expansion apparatus (e.g., expansion slots, serial ports, parallel ports, bus interfaces, USB ports) can be located inside the pan and tilt system.

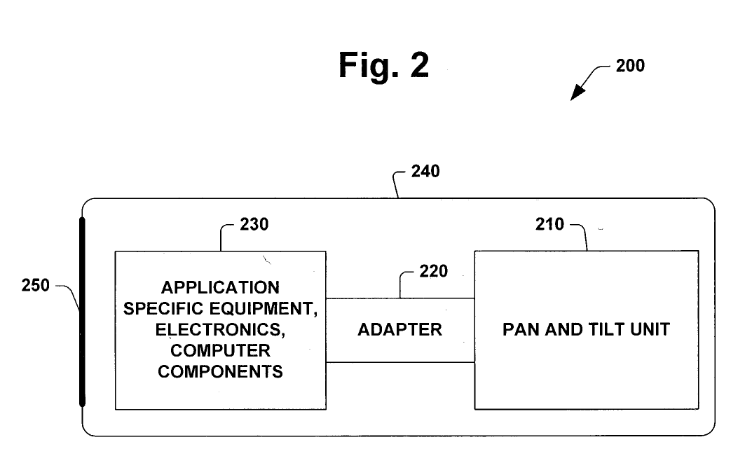

FIG. 2 illustrates an example system 200 that includes a pan and tilt unit 210, an adapter 220, and a set 230 of application specific equipment, electronics and/or computer components located inside a fairing 240 that has a fairing opening 250. Conventionally, a pan and tilt unit came pre-configured and was not adaptable. This limited the adaptability of a system. Thus, a fairing associated with a conventional system may not have been easily removable and/or may not have included an access panel or opening. With the additional space and load capacity of a system where the tilt axis pivots approximately about the center of mass of a payload and where the tilt axis is arranged perpendicular to and in the same plane as the pan axis, in some example systems, an adapter 220 is added to facilitate adding and/or removing application specific equipment, electronics, computer components, and the like. The adapter 220 may include, for example, electrical lines, data lines, physical connectors, and the like, as is typical in connecting sets of mechanical, electro-mechanical, computer component, and/or electrical equipment. To simplify adding and/or removing application specific equipment, electronics, computer components, and so on, the fairing 240 may be easily removable. Additionally, and/or alternatively, the fairing 240 may include a fairing opening 250 that can be employed to gain access to the adapter 220 and/or the application specific equipment and so on.

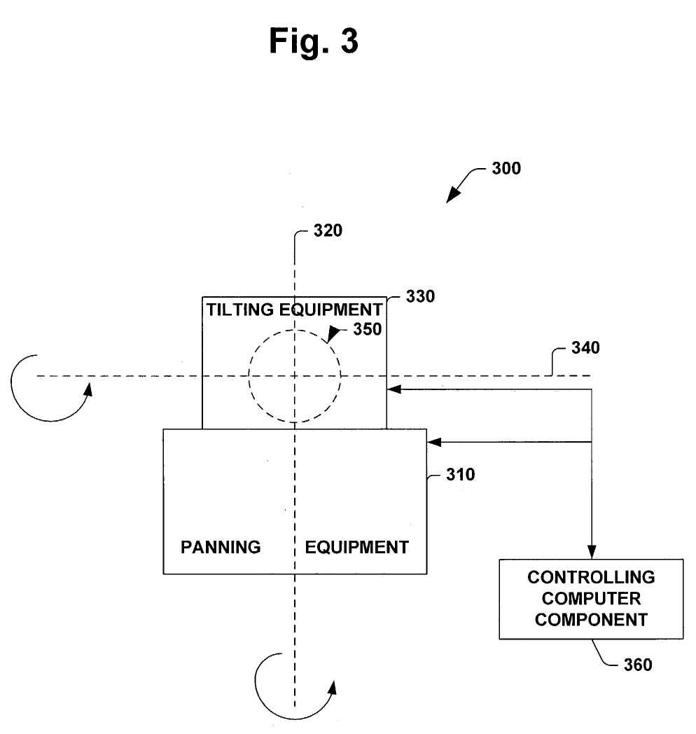

FIG. 3 illustrates a pan and tilt system 300. The system 300 includes a panning equipment 310 that facilitates panning a payload about a pan axis 320. The system 300 also includes a tilting equipment 330 connected to the panning equipment 310. The tilting equipment 330 facilitates tilting the payload about a tilt axis 340. In the system 300, the tilt axis 340 pivots approximately about the center of mass of the payload. Furthermore, the tilt axis 340 is arranged perpendicular to and in the same plane as the pan axis 320. The system 300 also includes an onboard controlling computer component 360 that controls one or more of the panning equipment 310 and the tilting equipment 330.

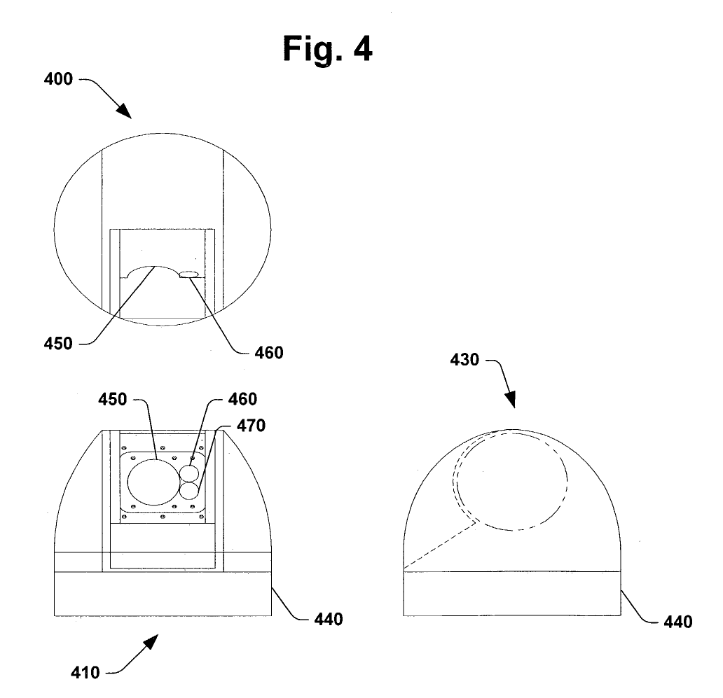

FIG. 4 illustrates top, front, and side views of an example pan and tilt IR system. Front view 410 illustrates a detachable electronics base 440. It is to be appreciated that the detachable electronics base 440 may not be present in all example pan and tilt IR system. In one example, the detachable electronics base 440 contains application specific electronics and/or computer components. Front view 410 also illustrates a main IR lens opening 450. The main IR lens opening 450 can accommodate various lens sizes. Front view 410 also illustrates two other openings 460 and 470. In one example, opening 460 may be an opening or lens area for a laser range finder transmitter while opening 470 may be an opening or lens area for a laser range finder receiver. While two openings 460 and 470 are illustrated, it is to be appreciated that a greater and/or lesser number of openings may be present. For example, an additional opening (not illustrated) may be employed for an additional camera (e.g., visible camera).

Top view 400 also illustrates the main IR lens opening 450 and opening 460. Side view 430 illustrates the detachable electronics base 440 and a substantially hemispherical fairing covering the pan and tilt IR system.

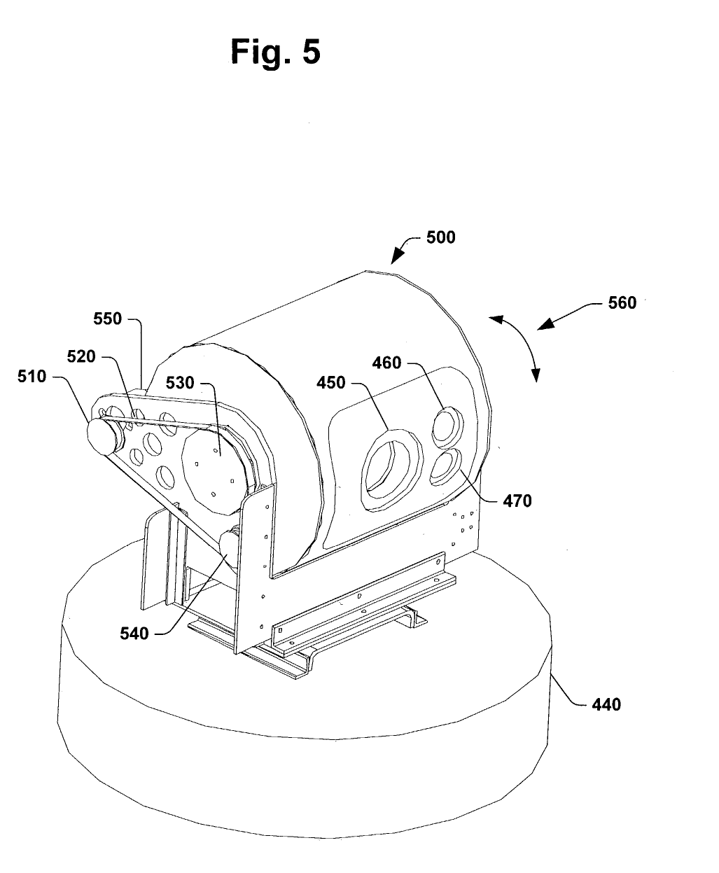

FIG. 5 illustrates a perspective view of portions of a pan and tilt IR system. The system includes detachable electronics base 440. Main IR lens opening 450 is visible in a payload container 500, as are openings 460 and 470 which may be employed, for example, for laser range finder transmitting and receiving. It is to be appreciated that in FIG. 5 the fairing has been removed from the pan and tilt IR system. It is also to be appreciated that the detachable base 440 may not appear in all example pan and tilt IR systems. In situations where the detachable base 440 does not appear, a mounting plate (not illustrated) may be employed to mount the pan and tilt IR system.

The perspective view illustrates an example tilt drive side view of an example pan and tilt system. A drive pulley 510 is connected by a drive belt 520 to a driven pulley 530. The drive pulley 510 is driven by a tilt drive motor 550 (partially visible). Conventionally, pan and tilt systems have employed gear and/or chain drive systems, with the disadvantages described above (e.g., snapback, looseness, lack of precision). A tensioning pulley 540 is also illustrated. The tensioning pulley 540 can facilitate, for example, adjusting the tension in the drive belt 520. The tilt drive apparatus (e.g., 510, 520, 530, 540, 550) facilitate rotating payload container 500 in the direction indicated by arc 560. As described above, the belt 520 employed by the tilt drive apparatus facilitates improving precision, response time, maintenance and noise characteristics of the pan and tilt IR system.

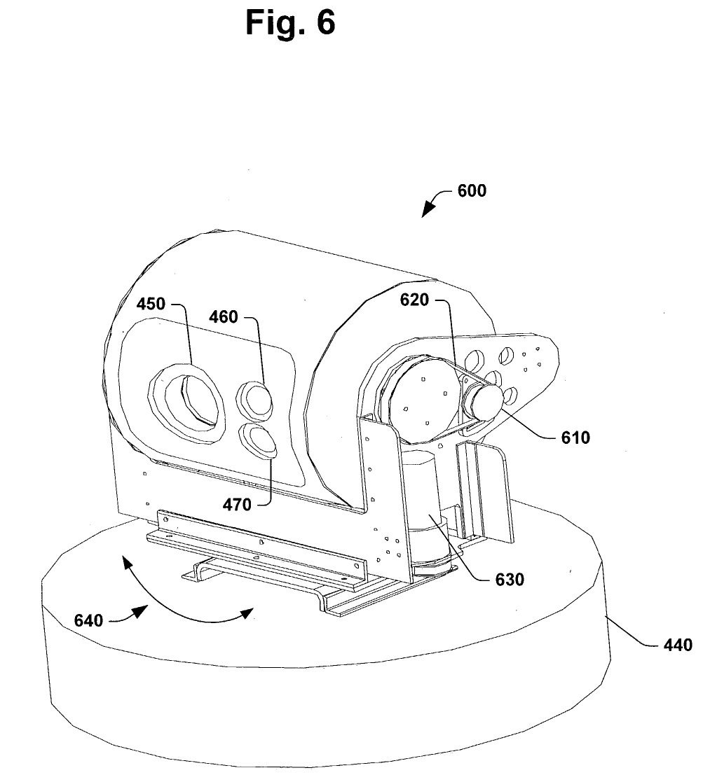

FIG. 6 illustrates an example tilt brake side view of an example pan and tilt IR system. The system includes detachable electronics base 440. Main IR lens opening 450 is visible in a payload container 600, as are openings 460 and 470 which may be employed, for example, for laser range finder transmitting and receiving. It is to be appreciated that in FIG. 6 the fairing has been removed from the pan and tilt IR system. It is also to be appreciated that the detachable base 440 may not appear in all example pan and tilt IR systems.

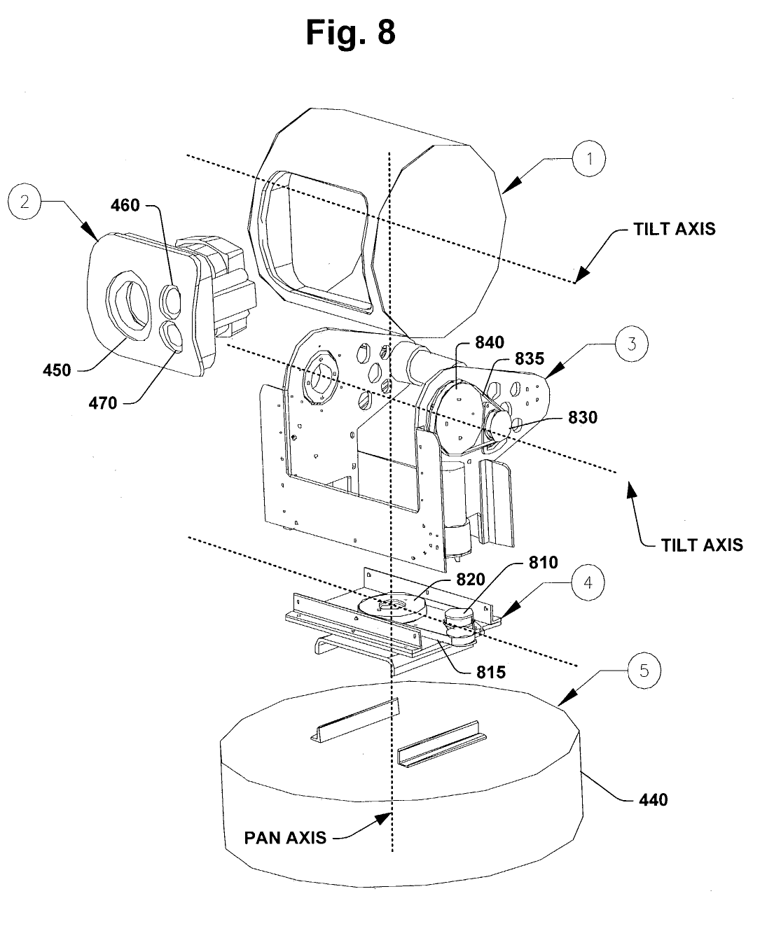

FIG. 6 also illustrates a pan axis motor 630 that facilitates rotating the payload container 600 in the direction indicated by arc 640. Pan axis motor 630 rotates the payload container 600 using another set (not illustrated in FIG. 6) of a drive pulley, a driven pulley, and a drive belt. These elements are illustrated in FIG. 8. Again, the drive belt facilitates improving precision, response time, maintenance and noise characteristics of the pan and tilt IR system.

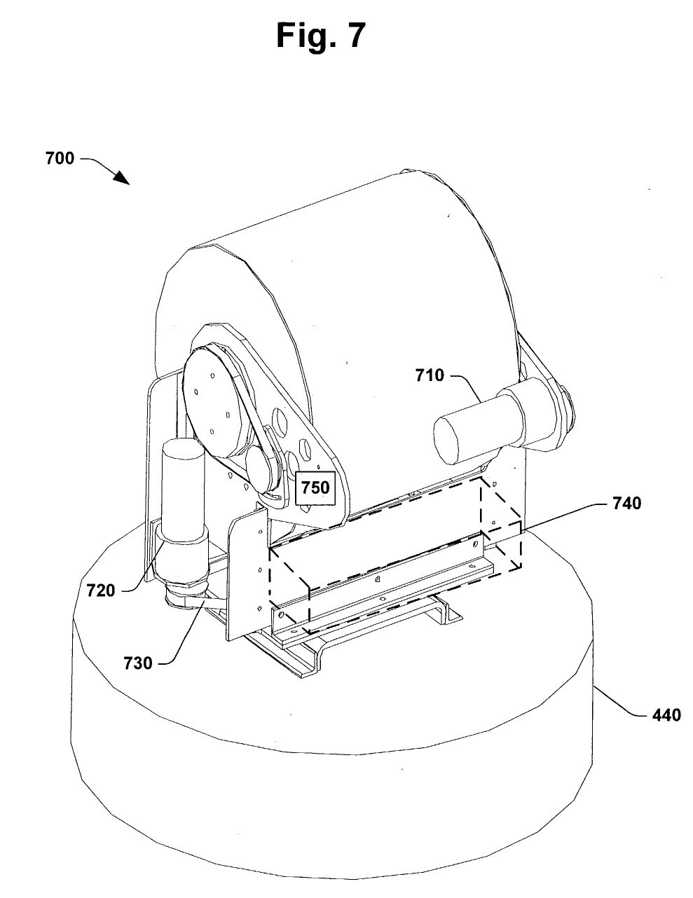

FIG. 7 illustrates a perspective view of a pan and tilt IR system. The system includes detachable electronics base 440. FIG. 7 illustrates tilt motor 710 which drives the tilt belt drive assembly illustrated in FIG. 5. FIG. 7 also illustrates a pan axis motor 720 driving a pan axis drive belt 730 which facilitates rotating the payload carrier 700 about the pan axis.

FIG. 7 also illustrates an on-board electronics box 740 (shown by dotted lines) that can hold, for example, electronics and/or computer components for a pan and tilt IR system. In one example, the on-board electronics box 740 can store one or more computer components of an intruder IR alert system. While on-board electronics box 740 is illustrated as a box, it is to be appreciated that other shapes, sizes and configurations are possible.

FIG. 7 also illustrates a tilt axis encoder 750. The tilt axis encoder 750 can be employed, for example, to facilitate controlling the tilting of the payload container 700 about the tilt axis.

FIG. 8 illustrates an exploded view of a pan and tilt IR system. The system includes detachable electronics base 440. FIG. 8 illustrates an assembly support and/or base interface 4 that supports a pan drive system (e.g., pan drive pulley 810, pan drive belt 815, driven pulley, 820). The payload container 1 can be rotated about a tilt axis. In one example, the tilt axis extends through a driven pulley 840 that is driven by a belt 835 driven by drive pulley 830. The payload container 1 can also be rotated about a pan axis. In one example, the pan axis extends through the driven pulley 820, so that the center of mass of the pan and tilt system and/or payload container 1 is substantially centered over the pan axis. Similarly, the payload container 1 and other components are arranged so that the center of mass of the pan and tilt system and/or payload container 1 is substantially centered over the tilt axis. The pan axis and tilt axis are arranged so that they are orthogonal to each other and are in the same plane. This provides advantages over conventional systems by removing the moment arm associated with the payload container that is typical in conventional systems.

FIG. 8 also illustrates an optics (e.g. IR, visual) assembly 2 that is carried by the payload container 1. While several components are illustrated in FIG. 8, it is to be appreciated by one skilled in the art that a pan and tilt IR system can include other elements not illustrated (e.g., data communications cables, survivable fairing).

What has been described above includes several examples. It is, of course, not possible to describe every conceivable combination of components for purposes of describing the example pan and tilt systems. However, one of ordinary skill in the art may recognize that further combinations and permutations are possible. Accordingly, this application is intended to embrace alterations, modifications, and variations that fall within the scope of the appended claims. Furthermore, the preceding description is not meant to limit the scope of the invention. Rather, the scope of the invention is to be determined only by the appended claims and their equivalents.

To the extent that the term “includes” is employed in the detailed description or the claims, it is intended to be inclusive in a manner similar to the term “comprising” as that term is interpreted when employed as a transitional word in a claim. Further still, to the extent that the term “or” is employed in the claims (e.g., A or B) it is intended to mean “A or B or both”. When the author intends to indicate “only A or B but not both”, then the author will employ the term “A or B but not both”. Thus, use of the term “or” herein is the inclusive, and not the exclusive, use. See BRYAN A. GARNER, A DICTIONARY OF MODERN LEGAL USAGE 624 (2d Ed. 1995).

What is claimed is:

1. A pan and tilt system, comprising:
a panning equipment that facilitates panning a payload about a pan axis;
a tilting equipment connected to the panning equipment, where the tilting equipment facilitates tilting the payload about a tilt axis, where the tilt axis pivots approximately about the center of mass of the payload and where the tilt axis is arranged perpendicular to and in the same plane as the pan axis; and
an onboard controlling computer component that controls one or more of the panning equipment and the tilting equipment.

2. The system of claim 1, the panning equipment comprising:
one or more motors for generating a force for panning the payload, where the one or more motors are connected to the panning equipment by a belt drive, and where the one or more motors are controllable by the onboard controlling computer component.

3. The system of claim 2, the tilting equipment comprising:
one or more motors for generating a force for tilting the payload, where the one or more motors are connected to the tilting equipment by a belt drive, and where the one or more motors are controllable by the onboard controlling computer component.

4. The system of claim 3, where the payload is one or more of a visible imaging camera, an infrared camera, a laser range finder, a directional microphone, and a GPS receiver.

5. The system of claim 3, where the payload is an infrared camera.

6. The system of claim 3, where the payload is an infrared camera and a visible imaging camera.

7. The system of claim 3, where the payload is a visible imaging camera.

8. The system of claim 3, comprising:
a survivable cover that substantially encloses the system.

9. The system of claim 8, where the survivable cover has a lens opening that accommodates a lens in the range 18 mm to 320 mm.

10. The system of claim 8, where the survivable cover is made from carbon fiber or Kevlar.

11. The system of claim 3, comprising:
a GPS receiver in data communication with the onboard controlling computer component where the onboard controlling computer component can selectively control the system based, at least in part, on data received from the GPS receiver.

12. The system of claim 3, comprising:
a communication protocol computer component that facilitates bidirectional communication between an extern system and the onboard controlling computer component.

13. The system of claim 12, where the communication protocol computer component implements one or more of a pan command, a tilt command, a status command, a reset command, a data communication check command, a zoom command, and an alarm command.

14. The system of claim 3, comprising:
an image colorization logic that colorizes an image received from a camera in the payload.

15. The system of claim 3, comprising:
a direct current receiver that receives direct current that is employed to power one or more of the one or more panning motors, the one or more tilting motors, and the onboard controlling computer component.

16. The system of claim 15, comprising:
an alternating current receiver that receives alternating current that is employed to power one or more of the one or more panning motors, the one or more tilting motors, and the onboard controlling computer component.

17. The system of claim 3, comprising:
a fiber optic apparatus that communicates a bidirectional data stream between one or more external entities and the onboard controlling computer component.

18. The system of claim 17, where the bidirectional data stream includes one or more of imaging data, command data, and status data.

19. The system of claim 18, where the bidirectional data stream is encrypted or compressed.

20. The system of claim 3, comprising:
an automatic repositioning logic that selectively controls the tilting motors or panning motors to reposition the payload upon the occurrence of a pre-determined condition.

21. The system of claim 3, comprising:
an image stabilizing logic that receives an image from one or more image generating sensors in the payload and stabilizes the image.

22. The system of claim 3, comprising:
a multi-drop serial network electrical interface.

23. The system of claim 3, comprising:
a target tracking logic that selectively controls the tilting motors or panning motors to reposition the payload upon detecting an object of interest.

24. The system of claim 3, comprising:
a climate control apparatus that selectively alters the climate inside the system.

25. The system of claim 3, where the one or more motors for generating a force for panning the payload are DC servo motors controlled by PWM.

26. The system of claim 3, where the one or more motors for generating a force for tilting the payload are DC servo motors controlled by PWM.

27. A pan and tilt system, comprising:
a panning equipment that facilitates panning a payload about a pan axis;
a tilting equipment connected to the panning equipment, where the tilting equipment facilitates tilting the payload about a tilt axis, where the tilt axis pivots approximately about the center of mass of the payload and where the tilt axis is arranged perpendicular to and in the same plane as the pan axis;
one or more panning motors for generating a panning force for panning the payload, where the one or more panning motors are connected to the panning equipment by a panning belt drive, and where the one or more panning motors are DC servo motors controlled via PWM;
one or more tilting motors for generating a tilting force for tilting the payload, where the one or more tilting motors are connected to the tilting equipment by a tilting belt drive, and where the one or more tilting motors are DC servo motors controlled via PWM;
one or more onboard computer components for controlling one or more of the panning motors, the tilting motors, the panning equipment, and the tilting equipment;
a direct current receiver that receives direct current that can be employed by one or more of the more panning motors and the tilting motors to produce the forces for panning or tilting the payload;
an alternating current receiver that receives alternating current that can be employed by one or more of the panning motors and the tilting motors to produce the forces for panning or tilting the payload;
a communication protocol computer component for receiving one or more control commands from an external computer component;
a fiber optic communicator that communicates a bidirectional data stream between an external computer component and the communication protocol computer component;
a survivable cover that substantially encloses the system;
an automatic repositioning logic that selectively controls the tilting motors or panning motors to reposition the payload upon the occurrence of a pre-determined condition;
an image stabilizing logic that receives an image from a camera in the payload and stabilizes the image;
an image colorization logic that colorizes an image received from a camera in the payload;
a target tracking logic that selectively controls the tilting motors or panning motors to reposition the payload upon detecting an object of interest;
a GPS receiver in data communication with the onboard computer components, where the onboard computer components selectively control the system based, at least in part, on data received from the GPS receiver; and
a climate control apparatus that selectively alters the climate inside the system.

28. The system of claim 27, where the payload is a visible imaging camera.

29. The system of claim 27, where the payload is an infrared camera.

30. The system of claim 27, where the payload is a visible imaging camera and an infrared camera.

31. The system of claim 27, where the one or more onboard computer components implement an infrared intruder alert system.

32. The system of claim 27, where the one or more onboard computer components implement a combined infrared and visual intruder alert system.

33. A pan and tilt system, comprising:
means for panning a payload about a pan axis;
means for tilting a payload about a tilt axis, where the means for tilting are connected to the means for panning and where the tilt axis associated with the means for tilting pivots approximately about the center of mass of the payload and where the tilt axis associated with the means for tilting is arranged perpendicular to and in the same plane as the pan axis associated with the means for panning;
means for applying a panning force, where the means for applying the panning force is connected to the means for panning by a belt drive;
means for applying a tilting force, where the means for applying the tilting force is connected to the means for tilting by a belt drive; and
an onboard computer component for controlling one or more of the means for panning, the means for tilting, the means for applying a panning force, and the means for applying a tilting force.
